(19) United States
(12) Patent Application Publication
(10) Pub. No.: US 2006/0103663 A1
(43) Pub. Date: May 18, 2006

(54) Method and system for real-time anti-aliasing using fixed orientation multipixels

(76) Inventor: David J. Collodi, Taylorville, IL (US)

Correspondence Address: BRINKS HOFER GILSON & LIONE, P.O. BOX 10395, CHICAGO, IL, 60610, US

(21) Appl. No.: 11/165,428

(22) Filed: Jun. 23, 2005

Related U.S. Application Data
(60) Provisional application No. 60/582,288, filed on Jun. 23, 2004.

(51) Int. Cl. G09G 5/00

(52) U.S. Cl. 345/611

(57) ABSTRACT

An improved method and system for generating real-time anti-aliased polygon images is disclosed. Fixed orientation multipixel structures contain multiple regions, each with independent color and depth value, and an edge position. Regions are constructed for polygon edge pixels which are then merged with current region values, producing new multipixel structures. Multipixel structures are compressed to single color values before the pixel buffer is displayed.

### RELATED APPLICATIONS

The present patent document claims the benefit of the filing date under 35 U.S.C. §119(e) of provisional U.S. patent application Ser. No. 60/582,288 filed Jun. 23, 2004, which is hereby incorporated by reference.

### BACKGROUND OF THE INVENTION

The present invention relates, in general, to the field of real-time computer generated graphics systems. In particular, the present invention relates to the field of polygon edge and scene anti-aliasing techniques employed in real-time graphics devices.

Anti-aliasing techniques are useful in improving the quality of computer generated images by reducing visual inaccuracies (artifacts) generated by aliasing. A common type of aliasing artifact, known as edge aliasing, is especially prominent in computer images comprised of polygonal surfaces (i.e. rendered three-dimensional images). Edge aliasing, which is characterized by a “stair-stepping” effect on diagonal edges, is caused by polygon rasterizing. Standard rasterization algorithms set all pixels on the polygon surface (surface pixels) to the surface color while leaving all other (non-surface) pixels untouched (i.e. set to the background color). Pixels located at the polygon edges must be considered either surface or non-surface pixels and, likewise, either set to the surface color or the background color. The binary inclusion/exclusion of edge pixels generates the “stair-stepping” edge aliasing effects. Nearly all other aliasing artifacts arise from the same situation—i.e. multiple areas of different color reside within a pixel and only one of the colors may be assigned to the pixel. Anti-aliasing techniques work by combining multiple colors within a pixel to produce a composite color rather than arbitrarily choosing one of the available colors. While other forms of aliasing can occur, edge aliasing is the most prominent cause of artifacts in polygonal scenes—primarily due to the fact that even highly complex scenes are chiefly comprised of polygons which span multiple pixels. Therefore, edge (and scene) anti-aliasing techniques are especially useful in improving the visual quality of polygonal scenes.

Many prior art approaches to edge/scene anti-aliasing are based on oversampling in some form or another. Oversampling techniques involve rendering a scene, or parts of a scene, at a higher resolution and then downsampling (averaging groups of adjacent pixels) to produce an image at screen resolution. For example, 4x oversampling renders 4 color values for each screen pixel, whereas the screen pixel color is taken as an average of the 4 rendered colors. While oversampling techniques are generally straightforward and simple to implement, they also present a number of significant disadvantages. Primarily, the processing and memory costs of oversampling techniques can be prohibitive. In the case of 4x oversampling, color and depth buffers must be twice the screen resolution in both the horizontal and vertical directions—thereby increasing the amount of used memory fourfold. Processing can be streamlined somewhat by using the same color value across each rendered pixel (sub-pixel) for a specific polygon fragment. This alleviates the burden of re-calculating texture and lighting values across sub-pixels. Each sub-pixel, however, must still undergo a separate depth buffer comparison.

There are several prior art techniques to reduce the processing and memory cost of oversampling. One such technique only stores sub-pixel values for edge pixels (pixels on the edge of polygon surfaces). This reduces the memory cost since edge pixels comprise only a small portion of most scenes. The memory savings, however, are balanced with higher complexity. Edge pixels now must be identified and stored and a separate buffer. Also a mechanism is required to link the edge pixels to the location of the appropriate sub-pixel buffer which, in turn, incurs its own memory and processor costs.

Another prior art strategy to reduce the memory costs of oversampling is to render the scene in portions (tiles) rather than all at once. In this manner, only a fraction of the screen resolution is dealt with at once—freeing enough memory to store each sub-pixel.

A variation of oversampling called pixel masking is also employed to reduce memory cost. Sub-pixels in masking algorithms are stored as color value—bit mask pairs. The color value represents the color of one or more sub-pixels and the bit mask indicates which sub-pixels correspond to the color value. Since most edge pixels consist of only 2 colors, this scheme can greatly reduce memory costs by eliminating the redundancy of storing the same color value multiple times.

While prior art techniques exist to reduce the memory and processor costs, traditional oversampling algorithms are also hindered by a relatively low level of edge quantization. Edge quantization can be though of as the number of possible variations between two adjacent surfaces that can be represented by a pixel in an anti-aliasing scheme. For example, using no anti-aliasing would produce an edge quantization of 2, since the pixel can be either the color of surface A, or the color of surface B. Using 4x oversampling (assuming each pixel is represented by a 2×2 matrix of sub-pixels), the edge quantization would be 3 since the pixel color can be either all A, half A and half B, or all B (assuming a substantially horizontal or vertical edge orientation). For an oversampling scheme, the edge quantization is proportional to the square root of the oversampling factor. Ideally, an edge quantization value of 256 is desired since it is roughly equivalent to the number of color variations detectable by the human eye. Since it is proportional to the square of the edge quantization, an oversampling factor of 65536x would be required to produce a edge quantization factor of 256. Such an oversampling factor would be impractical for real-time, memory limited rendering. Even using a pixel-masking technique, assuming only two colors (therefore necessitating only one mask), the bit mask for each pixel would need to be 65536 bits (or 8192 bytes) long to produce a 256 level edge quantization.

Oversampling and pixel masking techniques, while commonly used, are generally limited to small edge quantization values which can result in visual artifacts in the final rendered scene. Since an edge quantization value of 256 is impractical due to the memory and processing constraints of prior art techniques, there exists a need for a memory efficient and computationally efficient method and system for edge anti-aliasing capable of producing edge quantization values up to and exceeding 256.

### BRIEF SUMMARY OF THE INVENTION

The present invention details an improved method and system for rendering anti-aliased polygon images. A pixel structure is used to hold edge pixel information which includes multiple color and depth values, and a plurality of bits representing the position of an edge wherein the number of edge bits used is less than or equal to the edge quantization value produced. A prominent edge is first select from the pixel to be rendered. The angle and displacement of said prominent edge are calculated and used to produce a region structure wherein said region contains a color value, a depth value and a plurality of bits representing the position of the region's edge. Said region structure is then merged with the pixel structure corresponding to the current pixel, producing a new pixel structure. After the image is rendered, pixel structures for each pixel are converted to single color values which are output to a display device.

### BRIEF DESCRIPTION OF SEVERAL VIEWS OF THE DRAWINGS

FIG. 1 is an illustration of the fixed orientation multipixel structure.

FIG. 2 depicts several FOM structures with different dividing line values.

FIG. 3 shows a logic view of the pixel processing algorithm.

FIG. 4 illustrates the prominent edge of an pixel containing multiple edges.

FIG. 5 illustrates an angle vector, A, perpendicular to pixel edge E.

FIG. 6 illustrates the four sectors and corner points in a pixel.

FIG. 7 shows a logic diagram of the process of merging a new region with an existing FOM structure.

FIG. 8 illustrates the sections resulting from the merging of a region and an FOM.

FIG. 9 depicts an overview of a preferred hardware embodiment of the present invention.

### DETAILED DESCRIPTION OF THE INVENTION

The present invention presents a method and system to enable fast, memory efficient polygon edge anti-aliasing with high edge quantization values. The methods of the present invention are operable during the scan-line conversion (rasterization) of polygonal primitives within a display system. A preferred embodiment of the present invention is employed in computer hardware within a real-time 3D image generation system—such as a computer graphics accelerator or video game system and wherein real-time shall be defined by an average image generation rate of greater than 10 frames per second. Alternate embodiments are employed in computer software. Further embodiments of the present invention operate within non real-time image generation systems such as graphic rendering and design visualization software.

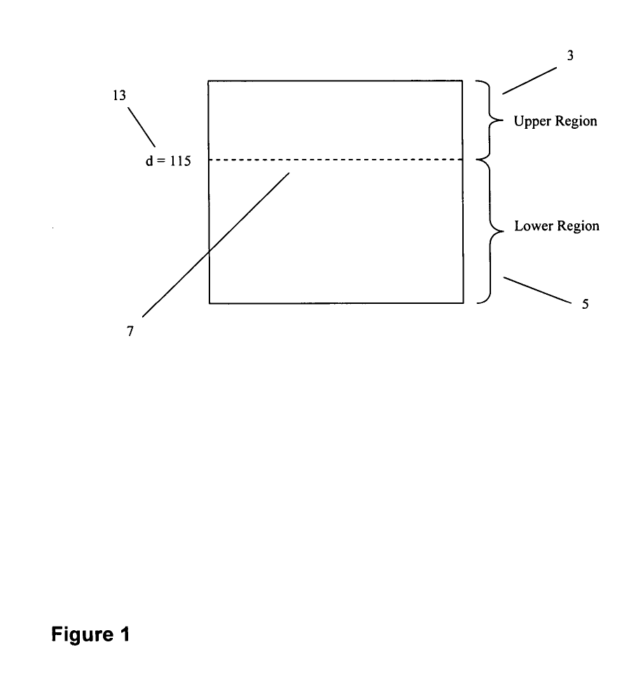

In order to provide high edge quantization values while keeping memory cost to a minimum, the present invention employs a pixel structure which shall heretofore be referred to as a fixed orientation multipixel (FOM). As illustrated in FIG. 1, the FOM structure consists of upper, 3, and lower, 5, regions separated by dividing line 7. Each region has a separate depth (Z) and color (C) value: Cᵤₚₚₑᵣ, Zᵤₚₚₑᵣ (9), C_{lower}, and Z_{lower} (11). The vertical position of the dividing line is represented by value d (13) which shall, for the sake of example, be expressed as an 8-bit (0-255) unsigned integer value. The d value specifies the area of the upper and lower regions (Aᵤₚₚₑᵣ, A_{lower}) where:

$$\begin{matrix}{A}_{upper} = \frac{d}{256} & ( 1 ) \\ {A}_{lower} = \frac{( 256 - d )}{256} & ( 2 )\end{matrix}$$

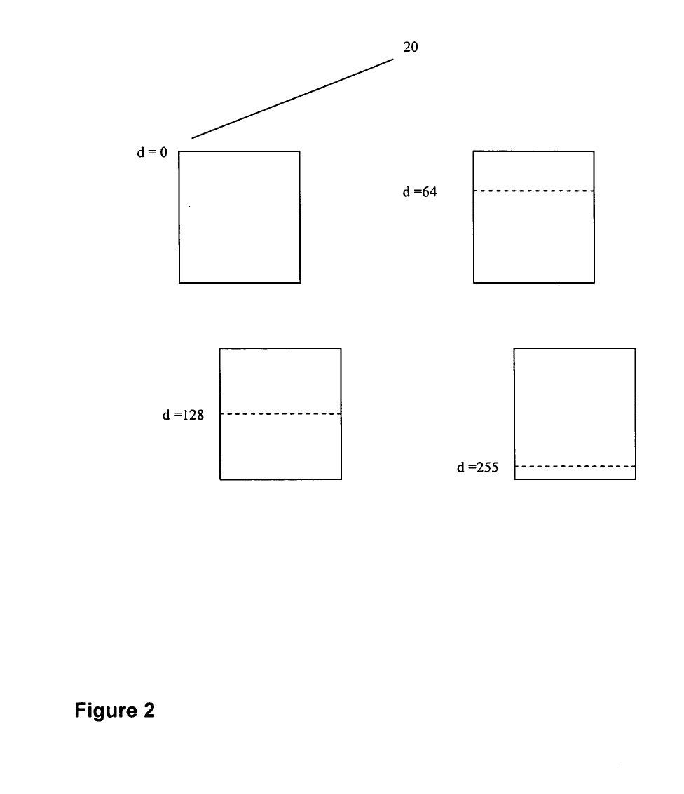

FIG. 2 illustrates multipixels with different dividing line d values. Note at 20, that a d value of zero indicates the lack of an upper region with the lower region accounting for 100% of the area of the pixel. Since the orientation of the dividing line is fixed, the division of area between the upper and lower regions can be represented solely by the d value. Using an 8-bit d value gives 256 levels of variation between the region areas, thereby giving an edge quantization value of 256. Using an n-bit d value, the edge quantization (EQ) is given by:
EQ=2″ (3)
Therefore a primary advantage of the FOM structure is that large edge quantization values can be represented with very little memory overhead. Each FOM structure requires twice the memory of a standard RGBAZ pixel (assuming the alpha channel from one of the color values is used as the d value). It is therefore feasible to represent every display pixel with an FOM structure as this would only require a moderate 2x increase in screen buffer memory size. A preferred embodiment of the present invention represents each display pixel with an FOM structure as previously defined. An alternate embodiment, however, stores non-edge pixels normally (single color and depth value) and only uses FOM structures to store edge pixels whereas referencing pointers are stored in the color or depth buffer locations corresponding to edge pixels.

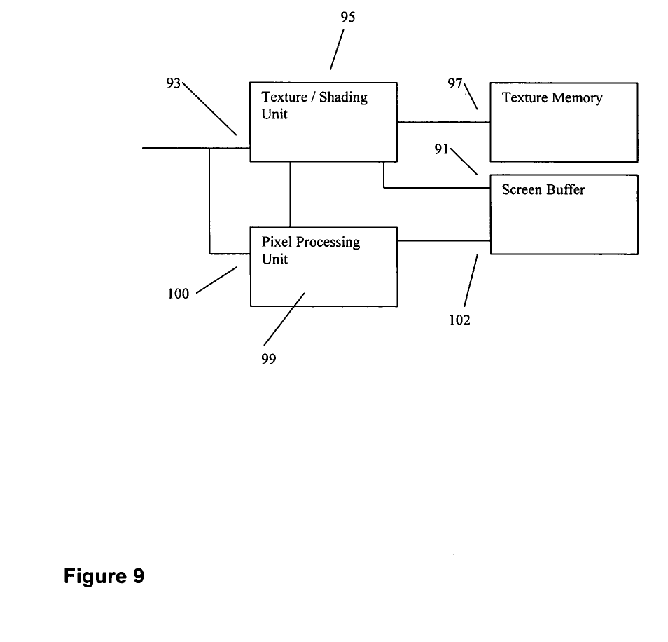

FIG. 9 illustrates a preferred hardware embodiment of the present invention. A texture and shading unit at 95 is operatively connected to a texture memory at 97 and a screen buffer at 91. The texture and shading unit computes pixel color from pixel data input at 93 and from internal configuration information, such as a stored sequence of pixel shading operations. Color data from the texture and shading unit is input to the pixel processing unit (99) along with pixel data at 100. The processing unit is operatively connected to the screen buffer at 102 and is capable of transferring data both to and from the screen buffer.

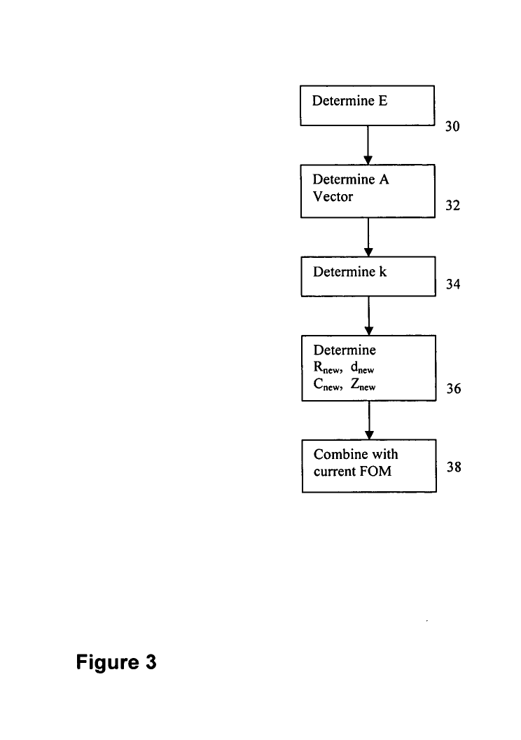

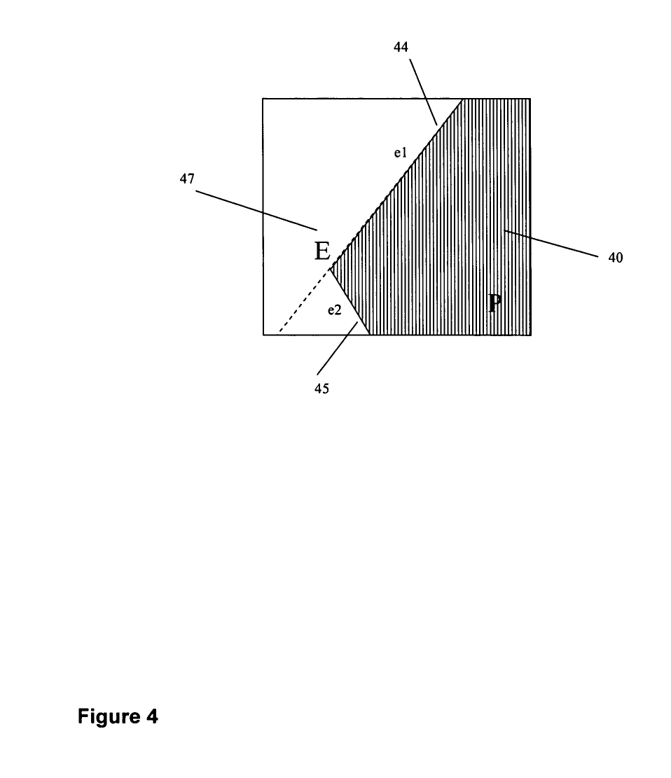

FIG. 3 broadly describes the pixel processing algorithm employed by the aforementioned pixel processing unit. At 30, the prominent edge, E, is determined. Since each FOM structure contains only one dividing line, only a single edge can be thusly represented. If an edge pixel of a particular polygon contains multiple edges, one of them must be selected. This edge shall be heretofore referred to as the prominent edge. FIG. 4 gives an example of the prominent edge of a multi-edge pixel. At 40, polygon fragment P, 42, has two edges, e₁ (44) and e₂ (45), which intersect the pixel. Methods for determining the edges intersecting a particular pixel are well known to those in the art. A preferred embodiment determines the prominent edge heuristically by simply selecting the longest of the available edges with respect to pixel boundaries. Any edge selection method, however, may be used by alternate embodiments to determine the prominent edge without departing from the scope of the present invention. At 47, e₁, as it is the longest, is chosen as prominent edge E.

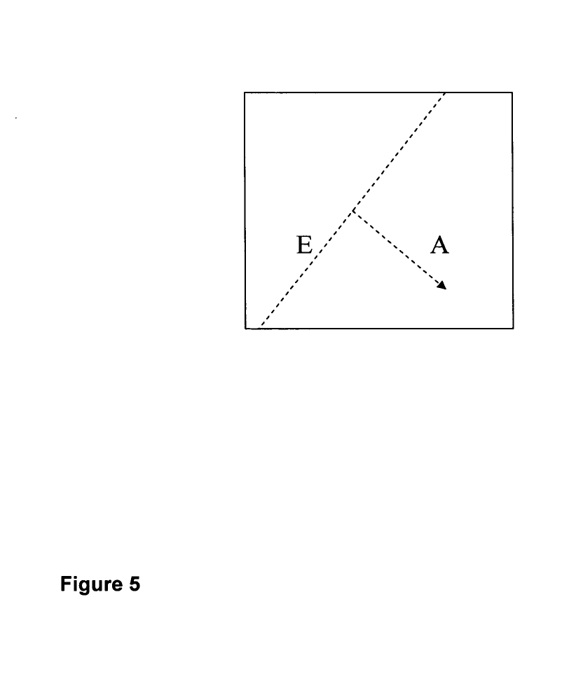

After the prominent edge, E, is determined, the edge angle vector, A, is next calculated (32). As illustrated in FIG. 5, the A vector is a two-dimensional vector perpendicular to E that, when centered at any point on E, extends towards the inside of the polygon. The A vector can be easily calculated using any two points on E. Assuming C and D are both points on E and that D is located counter-clockwise from C (about a point inside of the polygon), A is calculated as:

$$\begin{matrix}{A}_{x} = {C}_{y} - {D}_{y} & ( 4 ) \\ {A}_{y} = {D}_{x} - {C}_{x} & ( 5 )\end{matrix}$$

Next, at 34, edge displacement value, k, is calculated. In order to calculate k, the A vector must first be scaled by its Manhattan distance where:

$$A = \frac{A}{\vert {A}_{x} \vert + \vert {A}_{y} \vert} \qquad ( 6 )$$

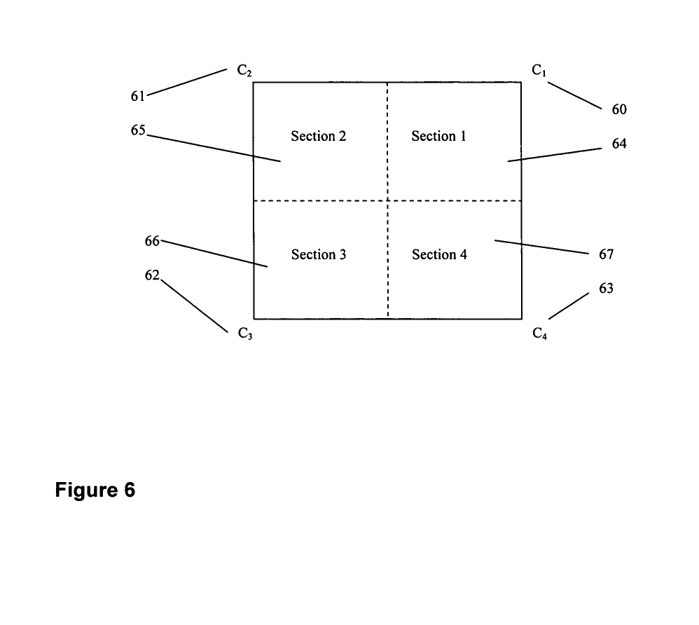

Next, a corner point must be chosen based on the sector that A falls in. FIG. 6 illustrates the four corner points (60, 61, 62, 63) and sectors (64, 65, 66, 67). Therefore, if Aₓ and A_{y} are both positive, A falls in sector 1 and corner point C₁ is selected. Likewise, if Aₓ is positive and A_{y} is negative, A is in sector 4 and C₄ is chosen. The displacement value k can now be calculated. Taking P to be any point on prominent edge E and Cₚ to be the chosen corner point, k is calculated as:
k=A·(Cₚ−P) (7)
Assuming a pixel unit coordinate system, k will have a scalar value between 0 and 1 representing the approximate portion of the pixel covered by the polygon surface.

At 36, A and k are used to generate new region information. Since FOM structures are comprised of only an upper and lower region, one of the two regions {UPPER, LOWER} must be assigned to the new sample. The A vector is used to assign the new sample's region flag, R_{new}. If A falls in sections 1 or 2 (64, 65), R_{new} is set to UPPER, otherwise R_{new} is set to LOWER. In order to maintain the property that opposite A vectors map to opposite regions, A vectors along the positive x-axis are considered to be in section 1 while A vectors along the negative x-axis are assigned to section 3. The k value is then used to calculate the new region's dividing line value, d_{new}. If R_{new} is UPPER:
d_{new}=k·256 (8)
If R_{new} is LOWER:
d_{new}=(1−k)·256 (9)
If the polygon pixel being rendered is not an edge fragment (i.e. the polygon surface entirely covers the pixel), an R_{new} value of LOWER and a d_{new} value of 0 are used. The color (C_{new}) and depth (Z_{new}) values for the new region are simply the color and depth values for the polygon pixel being rendered (i.e. the color and depth values that would normally be used if the scene were not anti-aliased).

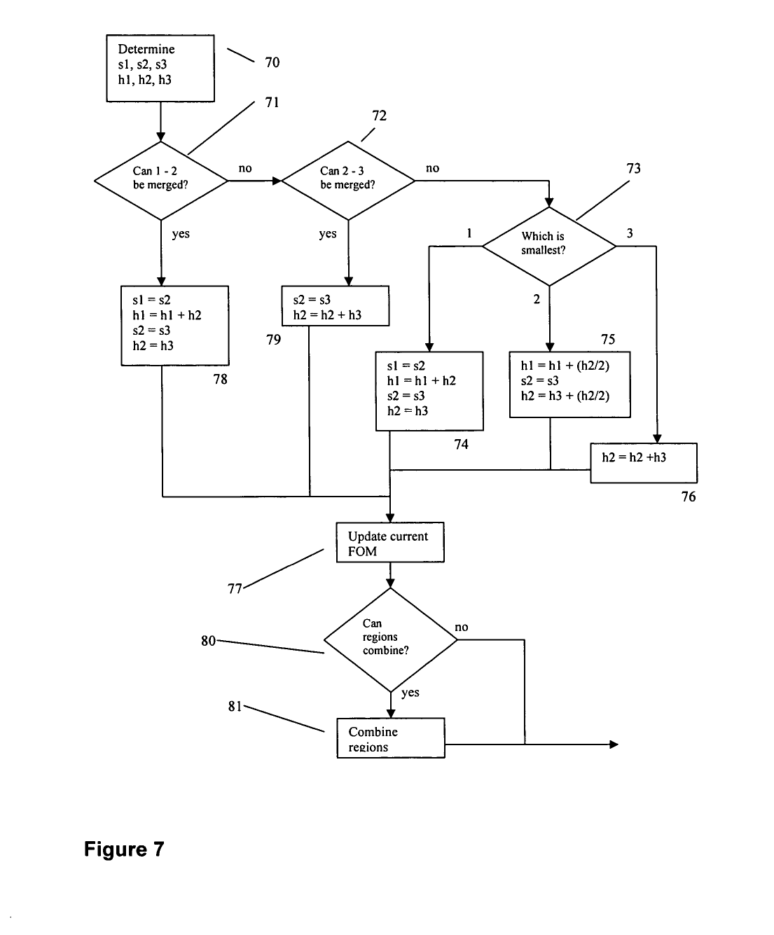

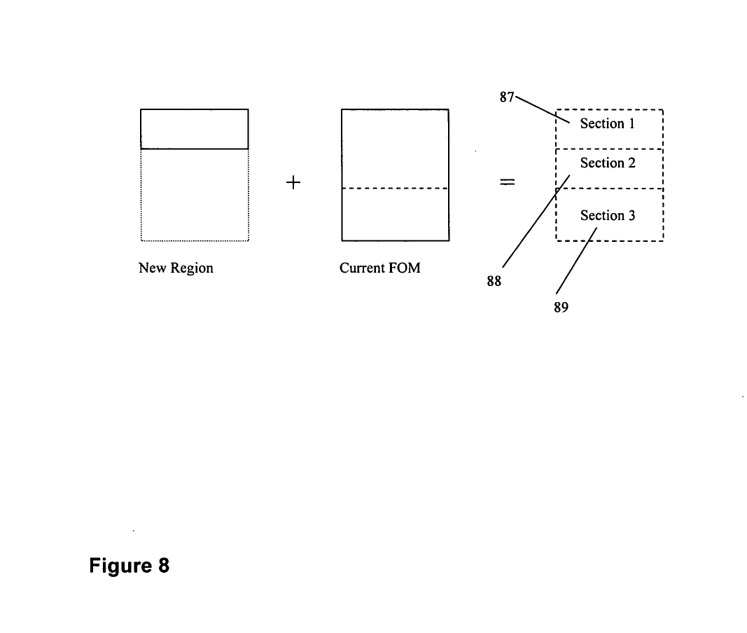

Finally, at 38, the new region is merged with the current FOM for the pixel. The new region comprises region flag R_{new}, dividing line value d_{new}, color value C_{new}, and depth value Z_{new}, as detailed above. The current FOM contains information about the current screen pixel and comprises an upper and lower region color value (Cᵤₚₚₑᵣ, C_{lower}), an upper and lower region depth value (Zᵤₚₚₑᵣ, Z_{lower}), and a dividing line value (d_{cur}). Since the new region and current FOM each have a potentially different dividing line value, their combination can have up to three sections of separate color and depth values. FIG. 8 illustrates the combination of a region (83) and an FOM (85) and the three potential sections (87, 88, 89) produced by the merge. The merge algorithm, in general, calculates the color and depth values for each section, then eliminates one or more sections to produce a new FOM. FIG. 7 presents a logic diagram detailing the process of merging the new region with the current FOM. At 70, information for each of the three sections is stored in local memory. Section content registers {s1, s2, s3} and height registers {h1, h2, h3} are used the store section information. FIG. 8 illustrates the logic involved in storing the section information. After section information is obtained, the content registers reference the region occupying each section while the height registers contain the section lengths. At 71, sections 1 and 2 are compared to determine if they can be merged. Two adjacent sections can be merged if they reference the same region or the height of one or both is zero. Sections 1 and 2 are merged at 78 (if possible). At 72, the possibility of merging sections 2 and 3 is determined. If a merge is possible, sections 2 and 3 are combined at 79. If neither pair of sections can be merged, the smallest section must be eliminated. The smallest section is determined at 73. Sections 1, 2, and 3 are deleted at (74, 75, 76). At 79, the current FOM is updated using information in s1, s2, and h1. The Cᵤₚₚₑᵣ and Zᵤₚₚₑᵣ values are assigned the region color and depth values referenced in s1. Likewise, C_{lower} and Z_{lower} are assigned the region color and depth referenced by s2. The FOM upper and lower regions may be combined if they have substantially the same depth value. At 80, Zᵤₚₚₑᵣ and Z_{lower} are compared. If Zᵤₚₚₑᵣ and Z_{lower} are equivalent (or within a predetermined distance of one another), the upper and lower regions are combined at 81, setting FOM values to:

$$\begin{matrix}{C}_{lower} = \frac{{d}_{cur}}{256} \cdot {C}_{upper} + \frac{256 - {d}_{cur}}{256} \cdot {C}_{lower} & ( 10 ) \\ {d}_{cur} = 0 & ( 11 )\end{matrix}$$

A preferred embodiment of the present invention implements the pixel processing algorithm illustrated in FIG. 3 and detailed above with dedicated hardware in a computer graphics device where said processing is applied to each drawn pixel. Specific hardware configurations capable of implementing the above-mentioned pixel processing algorithm are well known and, as should be obvious to those skilled in the applicable art, modifications and optimizations can be made to the implementation of said processing algorithm without departing from the scope of the present invention. Those skilled in the art will also recognize that multiple copies of the above detailed pixel processing unit may be employed to increase pixel throughput rates by processing multiple pixels in parallel. Alternate embodiments implement the pixel processing algorithm detailed above partially or entirely in software.

After the current FOM is updated, it is output to the screen buffer (102). The screen buffer of a preferred embodiment contains FOM information for each screen pixel. When the screen buffer is displayed to a video output, each FOM must be converted to a single pixel color before it can be displayed. To convert an FOM into a single pixel color, the upper and lower FOM regions are combined (as detailed above) and the C_{lower} value is used as the pixel color. A preferred embodiment employs dedicated hardware which combines FOM values to pixel colors.

### Description of a Second Embodiment

A second embodiment of the present invention is detailed below which allows anti-aliasing operations to be performed on composite scenes such as those created with deferred rendering where a number of rendered elements are combined to form the final image. In such cases, polygons may be rendered to alternate (non-color) output buffers whose data is not operable to be blended by the above operations. Furthermore, the above-mentioned output buffer data may in turn be used as input for additional pixel operations. In order to handle such cases, a modification of the present invention is presented that allows color blending to be delayed until the final image is composited.

In the second embodiment of the present invention, FOM structures are only used as elements of the depth buffer and are thusly modified. Firstly, the color information in the FOM structure (Cᵤₚₚₑᵣ, C_{lower}) is discarded, leaving only the depth and dividing line information. In addition, a single bit direction flag is appended to each FOM structure. The direction flag is used to indicate the approximate slope of the prominent edge represented by the FOM structure whereby a value of zero indicates an approximately horizontal slope (between 1 and −1) and a value of one indicates an approximately vertical slope (greater than 1 or less than −1).

The operations performed on the modified FOM structures are identical to those previously detailed with a few notable exceptions. Initially, when an edge pixel is assigned an FOM region, the region (upper or lower) is determined by the edge angle vector, A, where the R_{new} is set to UPPER when A_{y}>Aₓ and set to LOWER otherwise. The dividing line value, d, is determined as previously described but the direction flag value is additionally determined by the A vector such that a value of zero (horizontal) is used when |A_{y}|>|Aₓ| and a value of one (vertical) is used otherwise. Likewise, the process of combining the new region with the current pixel FOM is performed as previously described with the exception that the direction flag must be additionally updated. The direction flag for the current pixel is inverted when it differs from the direction flag of the merging region and the merging region is not eliminated in the merge (i.e. the merging region overwrites part of the current FOM). Alternate embodiments employ other algorithms for updating the direction flag such as inverting based on the relative area of the merging region. The optional post-merge step of combining regions of substantially equivalent depth value is not performed on the modified FOM structure of the second embodiment. Once the FOM structure for the current pixel has been merged, the decision must then be made whether or not to update the other output buffer(s) (such as the color or light buffer). The output buffer(s) are updated (overwritten or blended depending on the currently selected pixel operation) only if the merging region is not eliminated and the merging region is a LOWER region.

The second embodiment of the present invention operates by using a depth buffer composed of modified FOM structures to store depth/edge data along with a color buffer with the same resolution to store the final color data for the image. Any number of alternate output buffers may also be employed to store additional rendering data such as lighting, color and surface normal information. It is assumed that data from said alternate buffers will, at some point, be composited to produce the final image residing in the color buffer. Before the final image is displayed, the FOM depth buffer is used to reduce aliasing on the image in the color buffer by blending adjacent color pixels. Assuming that the depth and color buffers have the same resolution, each element of the depth buffer, Z_FOM(x, y), will therefore correspond to a unique element of the color buffer, C(x, y). For every depth buffer element, Z_FOM(x, y), with a dividing line, d, value greater than zero, the corresponding blended color value is calculated by:

$$\begin{matrix}{C}_{( x , y )} = \frac{d}{256} {C}_{( x - 1 , y )} + \frac{256 - d}{256} {C}_{( x , y )} \text{(direction flag is 1)} & ( 12 ) \\ {C}_{( x , y )} = \frac{d}{256} {C}_{( x , y - 1 )} + \frac{256 - d}{256} {C}_{( x , y )} \text{(direction flag is 0)} & ( 13 )\end{matrix}$$

The detailed description presented above defines a method and system for generating real-time anti-aliased images with high edge quantization values while incurring minimal memory overhead costs. It should be recognized by those skilled in the art that modifications may be made to the example embodiments presented above without departing from the scope of the present invention as defined by the appended claims and their equivalents.

I claim:

1. A system for providing anti-aliasing in video graphics having at least one polygon displayed on a plurality of pixels, wherein at least one pixel having a pixel area is covered by a portion of a polygon, the portion of the pixel covered by the polygon defining a pixel fragment having a pixel fragment area and a first color and the portion of the pixel not covered by the polygon defining a remainder area of the pixel and having a second color, the system comprising:
a graphics processing unit operable to produce a color value for the pixel containing the pixel fragment;
logic operating in the graphics processing unit that 1) converts the pixel fragment into a first polygon form approximating the area and position of the pixel fragment relative to the pixel area, the first polygon form having the first color, 2) converts the remainder_area into a second polygon form approximating the area and position of the remainder of the _pixel relative to the pixel area, the second polygon form having the _second color, 3) combines the first and second polygon forms into a pixel structure which defines an abstracted representation
_of the pixel area, and 4) the logic operable to produce an output signal created having a color value for the pixel based on a weighted average of the colors in the pixel structure.
